(19) United States
(12) Patent Application Publication
(10) Pub. No.: US 2025/0109316 A1
(43) Pub. Date: Apr. 3, 2025

(54) Two-Component Silicone-Based Coating Composition, Coating Method Using the Same and Article Thereof

(71) Applicant: Henkel AG & Co. KGaA, Duesseldorf (DE)

(72) Inventors: Wenyan Sun, Shanghai (CN); Hongyu Chu, Shanghai (CN)

(21) Appl. No.: 18/728,557

(22) PCT Filed: Jan. 28, 2022
(86) PCT No.: PCT/CN2022/074664

§ 371 Date: Jul. 12, 2024

(51) Int. Cl. C09D 183/04; B05D 1/18; B05D 3/02; B05D 3/10; C03C 17/30; C08G 77/04; C08G 77/08

(52) U.S. Cl. CPC C09D 183/04; B05D 1/18; B05D 3/0272; B05D 3/108; C03C 17/30; C08G 77/045; C08G 77/08; B05D 2203/35; B05D 2518/12; C08G 2150/00

(57) ABSTRACT

The present invention relates to two-component (2K) silicone-based coating composition comprising an effective amount of catalyst, an acrylic group containing tackifier, a crosslinker comprising pendant hydrosilyl group and optional terminal hydrosilyl group, a vinyl functional polysiloxane polymer, as well as to the use of the reaction product of such coating composition as a anti-shatter coating on a glass surface. This invention also provides a method of applying the coating composition on an article with glass surface, such as LED lighting bulb, for improving anti-impact property.

### TECHNICAL FIELD

The present invention relates to two-component (2K) silicone-based coating composition, a coating method using the same. More particularly, an article, particularly LED lighting bulb, having the composition coated on the bulb and a use of the composition as anti-shatter coating thereof.

### BACKGROUND OF THE INVENTION

More and more light emitting diodes (LED) lighting companies use glass as lamp cover to instead of polycarbonate (PC), which could achieve higher reliability and better performance of light transmission. However, since the bulb surrounding the LED module is made of a glass material which is still susceptible to impact, it is difficult to assemble, and it is liable to be damaged in assembly and transportation processes. In addition, exposure of LED chips may cause electrical shock accident, so all glass lamps, especially the ones for LED to be sold in North America, are required to pass an impact strength test. The applicable impact test is Underwriters Laboratories (UL) Standard for Polymeric Materials—Use in Electrical Equipment Evaluations (UL 746C), 2004 version, which contains specifications in section 56 “Resistance to Impact Test”, to test the impact strength of a material. Therefore, there is a need for a protection coating of LED glass bulb.

The silicone-based polyaddition curing system is well known to have several advantages, such as good mechanical properties, good thermal and chemical resistance, low shrinkage, no byproducts, and is used in several fields of application (food, dental, molding). However, to date, such systems suffer from overall poor adhesion, especially such system as coating on a glass surface after impact.

### SUMMARY OF THE INVENTION

There is a need to develop a silicone-based coating composition and coating process which is able to provide a high transparent coating with enhanced impact strength, particularly, good curing and good bonding performance. In addition, cured silicone composition need to be coated tightly and uniformly to a glass surface.

The present invention provides a silicone-based coating composition for glass bulb and glass surface of other articles with improved glass clarity, maintenance requirements and coating uniformity. It provides an efficient method for adhering a silicone-based coating tightly and uniformly to a glass surface, especially to the glass surface of ball lamp. It also provides silicone-based coating compositions which have good curing and bonding performance. In addition, the silicone-based coating compositions have high transparent and enhanced impact strength.

In one aspect, the present disclosure relates to a two-component silicone-based coating composition comprises: a component (A) comprising: an effective amount of catalyst, and a component (B) comprising: an acrylic group containing tackifier, a crosslinker comprising pendant hydrosilyl group and optional terminal hydrosilyl group, the component (A) and/or the component (B) comprising a vinyl functional polysiloxane polymer, the vinyl functional polysiloxane polymer having a vinyl functionality of greater than 2, and a vinyl content of less than 0.27 mmol/g based on the amount of the vinyl functional polysiloxane polymer, wherein the hydrosilyl group of the crosslinker is used in molar excess relative to the vinyl group of the vinyl functional polysiloxane polymer, and the mole ratio of hydrosilyl group of the crosslinker to vinyl group of the vinyl functional polysiloxane polymer being less than 1.3.

In another aspect, the present invention provides an addition-crosslinked reaction product of the two-component silicone-based coating composition of present invention.

The present invention also related to an article includes a coating of the addition-crosslinked reaction product of present invention on a glass surface. The article has an anti-impact property characterized by the article keeping as a whole with no crack when subjected to UL-746C impact test.

In another aspect, the present invention relates to a use of the reaction product as anti-shatter coating on an article with glass surface.

One more aspect of present invention provides a method for coating an article with a glass surface by using the composition, comprising steps of:
a) mixing component (A) and component (B),
b) dip-coating an article with glass surface in the mixture formed in step (a), or diluting the mixture formed in step (a) and then spraying the diluted mixture to an article with glass surface to form a coating on the glass surface,
c) curing the coating coated on the glass surface.

The present invention especially related to glass bulb comprising said cured coating coated on glass surface.

Further objects and advantages of this invention will be apparent from the following detailed description and examples of a presently preferred embodiment.

Compared with the prior art in the field, the advantage of the present invention is that the silicone-based coating composition and coating process which is able to provide a high transparent coating with enhanced impact resistance and good bonding. In addition, cured silicone composition could be coated tightly and uniformly to a glass surface.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “a vinyl group” encompasses embodiments having one, two or more said groups. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

The inventors of the present invention surprisingly found that the use of pendant hydrosilyl group-containing crosslinker, vinyl functional polysiloxane polymer and acrylic group containing tackifier as disclosed herein, in silicone-based coating compositions results in improved curing properties, bonding properties and impact resistant properties of the respective cured coating compositions on glass surfaces, especially on glass bulb surfaces.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

The terms “silicone-based” polymer is meant a polymer comprising one or more siloxane (—SiO—) units in the backbone. Such silicone-based polymers can include hybrid polymers, such as those comprising organic polymeric blocks with one or more-SiO-units in the backbone.

The term “hydrosily group” of this disclosure refers to —SiH functional groups, or a group comprising hydrogen atoms directly bonded to a silicon atom. The term “terminal hydrosily group” is meant containing hydrosily groups (—SiH) on terminal ends of the polymer. The term “pendant hydrosily group” refers to hydrosily groups (—SiH) on pendant positions of the polymer.

The term “vinyl functional”, as used herein, refers to a compound comprising at least one vinyl moiety. Examples of vinyl functional, as defined herein, that comprise one vinyl moiety include, for instance and without limitation, vinyl (ethenyl), allyl (2-propenyl), and 3-butenyl. Examples of vinyl group containing groups, as defined herein, that comprise two vinyl moieties include, for instance and without limitation, hex-3,5-dienyl and octa-4,6-dienyl. The vinyl functional polysiloxane polymer is a molecule that comprises a vinyl group, as defined above, and the Si—C bonds.

As used herein, the term “cure” as used in connection with a composition, e.g., “composition when cured,” shall mean that any crosslinkable components of the composition are at least partially crosslinked. In certain embodiments of the present invention, the crosslink density of the crosslinkable components, i.e., the degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a TA Instruments DMA 2980 DMTA analyzer conducted under nitrogen. This method determines the glass transition temperature and crosslink density of free films of coatings or polymers. These physical properties of a cured material are related to the structure of the crosslinked network.

The term “silane”, as used in relation to such a molecule, thus covers compounds that comprise the —Si(ORₐ)₃ group as the only silicon containing group. Preferably, the component A can comprise polysiloxanes having at least one vinyl group in one molecule, preferably a mixture of at least one linear polysiloxane having at least one vinyl group and at least one branched polysiloxane having at least one vinyl group in one molecule, more preferably a vinyl functional MQ polyorganosiloxane.

The terms “mass” and “weight” are used synonymously herein. Thus “percent by weight” (% by weight) means the percentage by mass content, based on the mass (by weight) of the entire composition or on the basis of all molecules, unless otherwise stated.

“Room temperature” means a temperature of 25±2° C.

“Kinematic viscosity” of crosslinker could be tested by Brookfield digital viscometer BF, using spindle 7, at 5 rpm according to EN ISO 2555.

### Catalyst

The component A comprises at least an effective amount of catalyst to promote hydrosilylation reaction.

Hydrosilylation catalysts are known in the art and are commercially available. These catalysts can be selected from the group consisting of platinum, palladium, rhodium, nickel, iridium, ruthenium, cobalt, ferrum, cuprum catalysts, and mixtures thereof, preferably platinum catalyst, which can efficiently promote the reaction of hydrosilyl groups (—SiH) with vinyl groups. Preferably, the catalysts comprise a platinum group metal selected from the group consisting of platinum, rhodium, ruthenium, palladium, osmium or iridium metal or organometallic compound thereof, and a combination thereof.

It is possible to use commercially available products in present invention. Suitable hydrosilylation catalysts include platinum (0) complexes with divinyl tetramethyl disiloxane or with methyl vinyl cyclosiloxane, obtainable as Catalysts 512 and 520, respectively, from Evonik Industries. Examples also include Karstedt catalyst, e.g., Karstedt PT1003 available from AB Silicone or C-25A from ShinEtsu.

With preference, the catalyst could be incorporated into the coating composition in an effective amount of from 0.01% to 3% by weight, preferably in an amount of from 0.02% to 2.5% by weight, such as 0.02%, 0.03%, 0.04%, 0.05%, 0.06%, 0.07%, 0.08%, 0.1%, 0.5% by weight, based on the total amount of the coating composition.

### Vinyl Functional Polysiloxane Polymer

The component A and/or the component B comprises at least one vinyl functional polysiloxane polymer.

The term “vinyl functional”, as used herein, refers to a compound comprising at least one vinyl moiety. Examples of vinyl functional groups, as defined herein, that comprise one vinyl moiety include, for instance and without limitation, vinyl (ethenyl), allyl (2-propenyl), and 3-butenyl. Examples of vinyl containing groups, as defined herein, that comprise two vinyl moieties include, for instance and without limitation, hex-3,5-dienyl and octa-4,6-dienyl.

“Alkyl”, as used in the context of the present invention, relates to a linear or branched hydrocarbon group having 1 to 20 carbon atoms. As non-limiting examples thereof, methyl, ethyl, propyl, isopropyl, tert-butyl, n-pentyl, and isopentyl may be mentioned.

It is possible to use commercially available products in the present invention. Examples there of include VQM resin from AB Specialty Silicone Co., Ltd, such as Andisil VQM 6, Andisil VQM 60 or VQM881, VQM 885 from Evonik.

In some embodiments, the vinyl functionality of the vinyl functional polysiloxane polymer is greater than 2, and the vinyl content is less than 0.27 mmol/g, preferably less than 0.21 mmol/g, based on the total amount of the vinyl functional polysiloxane polymer.

With particular preference, the hydrosilyl group of the crosslinker is used in molar excess relative to the vinyl group of the vinyl functional polysiloxane polymer, and the mole ratio of hydrosilyl group of the crosslinker to vinyl group of the vinyl functional polysiloxane polymer is less than 1.3, such as 1.0016, 1.002, 1.007, 1.01, 1.03, 1.04, 1.06, 1.07, 1.1, 1.13, 1.16, 1.2, 1.23, 1.25, 1.28, 1.298.

### Crosslinker

The component B comprises a crosslinker comprising pendant hydrosilyl group and optional terminal hydrosilyl group.

Crosslinker (also called “Crosslinking agents”) suitable in the context of the present invention are known in the art and may include, for instance, compounds that comprise at least two, preferably more than two pendant hydrosilyl-groups. Preferred are modified PDMS polymers with —SiH groups within the chain and, optionally, also at the terminal.

The crosslinker of the invention may be liquid at application temperatures. It is preferred that the silicone-based coating compositions of the invention are liquid at room temperature. In various embodiments, crosslinker according to the present invention have a kinematic viscosity of equal to or greater than 45 cst (1 cst=1 mm²/s) at a temperature of 25° C. as determined in DIN EN ISO 3219, measured with Haake PK100 (RV 20 or RV30), RT 20, Physica MCR 301 or equivalent rheometers. “Liquid”, as used herein, includes gels and pastes. It was surprisingly found that an advantageously balance between uniform coating and adhesiveness can be achieved if the crosslinker of the coating composition is chosen within the above ranges.

It is possible to use commercially available products in the present invention. Examples there of include pendant hydrosilyl group containing siloxane, from AB Specialty Silicone Co., Ltd, such as Andisil X 1340, Andisil XL 10.

### Tackifier

The component B of the silicone-based coating composition according to the present invention further comprises at least one tackifier which contains acrylic group. Suitable tackifiers include (meth)acrylic group containing silane and (meth)acrylic group containing resin.

It will be apparent to those skilled in the art that when silane is used as a tackifier, it is possible for the silane to be present in a partially or fully hydrolyzed form depending on conditions such as humidity. It is also known to the person skilled in the art that in the presence of such partially or fully hydrolyzed silanes, oligomeric siloxanes, in particular dimers and/or trimers, can be formed by condensation reactions.

The content of tackifier in the coating composition according to the invention is preferably between 0.1 and 5% by weight, in particular between 0.15 and 3% by weight, particularly preferably between 0.25 and 1% by weight, based on the total weight of the two-component silicone-based coating composition.

It is possible to use commercially available products in the present invention. Examples there include (meth)acrylic group containing silane and (meth)acrylic group containing resin, commercially available from Shin Etsu Chemical Co., Ltd., such as KBM 5103, KBM 503 or SIA 0200.0 from Gelest, Andisil 174 silane from AB silicone.

### Solvent

The reaction products of two-component silicone-based coating compositions are typically formed, e.g., via spraying, on a neat glass surface and in the presence of an appropriate hydrosilylation catalyst. Organic solvent is needed for spraying process.

The reaction products of two-component silicone-based coating compositions are typically formed, e.g., via dip-coating, on a neat glass surface and in the presence of an appropriate hydrosilylation catalyst. Organic solvent is not needed for dip-coating.

The coating compositions of the present invention can be solvent-based compositions, water-based compositions (need further emulsification), in solid particulate form, that is, a powder composition, in the form of a powder slurry or an aqueous dispersion.

The components of the present invention used to form the coating compositions of the present invention can be dissolved or dispersed in an organic solvent. Nonlimiting examples of suitable organic solvents include alcohols, such as butanol; ketones, such as methyl amyl ketone; aromatic hydrocarbons, such as xylene; and glycol ethers, such as, ethylene glycol monobutyl ether; esters; other solvents; and mixtures of any of the foregoing.

Both aromatic and aliphatic solvents can be used for the silicone dispersions, however, aromatic solvents are most commonly used for silicone dispersions. Typical examples of useful aromatic solvents include, but are not limited to, xylene and toluene. Aliphatic solvents which are useful include, but are not limited to, esters, pentane, heptanes, hexane and their mixtures. An example of an aliphatic solvent mixture is Exxon Isopar K solvent. The organic solvents are added at a concentration sufficient to provide effective blending of the silicone polymer components into a homogeneous coating solution. The total solvent concentration sufficient to be effective is typically between about 5 wt. % to about 90 wt. %, and is more typically between about 40 wt. % to about 80 wt. %, depending upon the coating thickness requirement. Those skilled in the art will appreciate that the coating thickness can be engineered by changing the solids content of the coating solution.

### Optional Additives

The coating composition of the present invention may further comprise optional additives. The selection of suitable additives for the coating composition depends on the specific intended use of the coating composition and can be determined in the individual case by those skilled in the art.

### Preparing Method of the Coating Composition

For the two-component silicone-based coating composition according to the present invention, the formation of such a polymer occurs in the preparation of the component (B), that is, prior to the mixing of components (A) and (B). Methods for the preparation of both the component (A), as described herein, and the component (B), as described herein, are known in the art.

The two components (A) and (B) are stored separately until use. For use, the two components are mixed together in a manner known per se. In separated form, the two components (A) and (B) are storage stable.

The following procedure as described utilizes conventional mixing equipment in typical production facilities. The coating composition component A of the present invention may be preferably prepared in the following manner. Initially, a vinyl-functional polysiloxane polymer component such as vinyl terminated polydimethylsiloxane is added to a conventional mixing vessel together with a catalyst and mixed for a sufficiently effective time until fully homogeneous. The coating composition component B of the present invention may be preferably prepared in the following manner. A vinyl-functional polysiloxane polymer component such as vinyl terminated polydimethylsiloxane, a crosslinker such as hydrosilyl group containing crosslinker Andisil XL 1340 and then other compounds are fully blended for a sufficiently effective time in a mixing vessel. Other conventional blending and mixing processes and equipment may be used to manufacture the silicone-based coating compositions of the present invention. For example, the sequence can be modified to some extent when using various other suitably effective conventional mixing equipment, such as a double planetary mixer. All of the components may be mixed in one step in such equipment.

For the coating composition comprising optional organic solvent, the amount of organic solvent in the coating compositions of the present invention will typically be about 5 wt. % to about 90 wt. %, more typically about 40 wt. % to about 80 wt. %, and preferably about 45 wt. % to about 68 wt. %. Those skilled in the art will appreciate that the amount of solvent present in the novel coating compositions of the present invention will vary with several factors, and that the solvent quantity in the coating compositions will be selected to engineer an efficacious coating. The factors typically considered include the method of application, the method of cure, the coating equipment utilized, ambient conditions, thickness, etc. It will be appreciated that each of the components of the coating compositions of the present invention may consist of blends of those components.

### Coating Process

In the application of the two-component silicone-based coating composition, the component (A) and the component (B) are mixed with each other, for example, by stirring, kneading, rolling, or the like, particularly by a static mixer.

For a two-component silicone-based coating composition, as described herein, the two components (A) and (B) of the coating are mixed immediately before application. The adhesive composition is subsequently applied to one or more glass surfaces of a lighting device, such as a LED bulb, using conventional coating techniques and processes and conventional coating equipment. One example of coating equipment that can be used to apply the coatings includes, but is not limited to, simple dip-coating tanks and in-line convection ovens for curing. The coating compositions can also be adjusted to suitable viscosity and applied by conventional brushing, rolling, or spraying processes, and any equivalent processes. Prior to coating, the surfaces of the lighting devices will be prepared in a conventional manner using conventional processes such as ultrasonic cleaning, plasma etch, chemical cleaning, and the like. After coating, keep the lighting device, such as the LED bulb upturned.

### Curing Process

The hydro-silylation addition cross-linking reaction can be completed (i.e., the coating can be cured) in-line by passing the coated device through a heating oven for a sufficiently effective time. The curing times will vary, for example, from about 5 seconds to about 24 hours, and will vary with respect to parameters such as the crosslinker concentration, catalyst concentration, coating thickness, ambient conditions, device construction and bulb shape, etc. However, the curing times can be as short as about 2 minutes at 120° C., or about 5 seconds at 180° C. Other conventional curing techniques which can be utilized with the coating compositions of the present invention include thermal (e.g., convection heating), ultraviolet light, plasma, microwave radiation, electromagnetic coupling, ionizing radiation, laser, and the like.

If desired, a batch coating and curing process can also be used rather than an in-line process.

### LISTING OF EMBODIMENTS

1. A two-component silicone-based coating composition comprises:
   a component (A) comprising: an effective amount of catalyst, and
   a component (B) comprising: an acrylic group containing tackifier, a crosslinker comprising pendant hydrosilyl group and optional terminal hydrosilyl group,
   the component (A) and/or the component (B) comprising a vinyl functional polysiloxane polymer, the vinyl functional polysiloxane polymer having a vinyl functionality of greater than 2, and a vinyl content of less than 0.27 mmol/g,
   wherein the hydrosilyl group of the crosslinker is used in molar excess relative to the vinyl group of the vinyl functional polysiloxane polymer, and the mole ratio of hydrosilyl group of the crosslinker to vinyl group of the vinyl functional polysiloxane polymer being less than 1.3.
2. The composition according to embodiment 1, wherein the crosslinker has a kinematic viscosity of equal to or greater than 45 cst at 25° C.
3. The composition according to any one of preceding embodiments, wherein vinyl functional polysiloxane polymer is selected from is selected from the group consisting of vinyl terminated: polydialkylsiloxane, polydimethylsiloxane, polydiphenylsilane-dimethylsiloxane copolymer, polyphenylmethylsiloxane, polyfluoropropylmethyl-dimethylsiloxane copolymer and polydiethylsiloxane.
4. The composition according to any one of preceding embodiments, wherein vinyl functional polysiloxane polymer has a vinyl content of less than 0.21 mmol/g.
5. The composition according to any one of preceding embodiments, wherein the crosslinker is selected from the group consisting of polymethylhydrogensiloxane, polymethylhydrogen-polydimethylsiloxane copolymer, polyethylhydrogensiloxane, methyl Hydrogensiloxane-octylmethylsiloxane copolymer and methylhydrogensiloxane-methylphenylsiloxane copolymer.
6. The composition according to any one of preceding embodiments, wherein the acrylic group containing tackifier comprises (meth)acrylic resin, (meth)acrylic silane.
7. The composition according to any one of preceding embodiments, wherein the content of the acrylic group containing tackifier is 0.2 wt. % to 5 wt. % based on the total weight of the composition.
8. The composition according to any one of preceding embodiments, wherein the catalyst is selected from a group consisting of platinum, palladium, rhodium, nickel, iridium, ruthenium, cobalt, ferrum, cuprum catalyst, and mixtures thereof.
9. The composition according to any one of preceding embodiments, wherein the composition further comprises 5 wt. % to 90 wt. % of organic solvent based on the total weight of the composition.
10. An addition-crosslinked reaction product of the two-component silicone-based coating composition of any one of preceding embodiments.
11. The reaction product of embodiment 10, wherein the reaction product has a transmittance of greater than or equal to 95%.
12. An article includes a coating of the reaction product of anyone of embodiments 10 to 11 on a glass surface.
13. The article of embodiment 12, wherein the article has an anti-impact property characterized by the article keeping as a whole with no crack when subjected to UL-746C impact test.
14. A use of the reaction product of embodiment 10 as anti-shatter coating on an article with glass surface.
15. A method for coating an article with a glass surface by using the composition according to any one of preceding embodiments, comprising steps of:
   a) mixing component (A) and component (B),
   b) dip-coating an article with glass surface in the mixture formed in step (a), or diluting the mixture formed in step (a) and then spraying the diluted mixture to an article with glass surface to form a coating on the glass surface,
   c) curing the coating coated on the glass surface.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

Raw Materials

| Component | Trade Name | Description | Supplier |
|---|---|---|---|
| Catalyst | Karstedt | Chloroplatinic | AB specialty |
| | PT1003 | Acid in Vinyl | silicones |
| | | polymer | (Nantong) |
| | | | Co., Ltd |
| Vinyl | Andisil | Fn > 2, [vinyl] = | AB specialty |
| functional | VQM 60 | 0.20 mmol/g | silicones |
| polysiloxane | | | (Nantong) |
| polymer | | | Co., Ltd |
| Vinyl | Andisil | Fn > 2, [vinyl] = | AB specialty |
| functional | VQM 6 | 0.22 mmol/g | silicones |
| polysiloxane | | | (Nantong) |
| polymer | | | Co., Ltd |
| Vinyl | Andisil | Fn > 2, [vinyl] = | AB specialty |
| functional | VQM 0.6 | 0.3 mmol/g | silicones |
| polysiloxane | | | (Nantong) |
| polymer | | | Co., Ltd |
| Vinyl | Andisil | Fn = 2, [vinyl] = | AB specialty |
| functional | VS 5000 | 0.06 mmol/g | silicones |
| polysiloxane | | | (Nantong) |
| polymer | | | Co., Ltd |
| Crosslinker | Andisil | Comprising both | AB specialty |
| | XL 1340 | pendant and terminal | silicones |
| | | hydrosilyl group | (Nantong) |
| | | (—SiH), [Si—H] = 3.0 | Co., Ltd |
| | | mmol/g, kinematic | |
| | | viscosity = 50 cst | |
| Crosslinker | Andisil | Comprising both | AB specialty |
| | XL 1341 | pendant and terminal | silicones |
| | | hydrosilyl group | (Nantong) |
| | | (—SiH), [Si—H] = 4.2 | Co., Ltd |
| | | mmol/g, kinematic | |
| | | viscosity = 40 cst | |
| Crosslinker | Andisil | Comprising both | AB specialty |
| | XL 10 | pendant and terminal | silicones |
| | | hydrosilyl group | (Nantong) |
| | | (—SiH), [Si—H] = 7.55 | Co., Ltd |
| | | mmol/g, kinematic | |
| | | viscosity = 45 cst | |
| Crosslinker | Andisil | Comprising only | AB specialty |
| | CE-4 | terminal hydrosilyl | silicones |
| | | groups (—SiH), | (Nantong) |
| | | [Si—H] = 2.90 mmol/g, | Co., Ltd |
| | | kinematic | |
| | | viscosity = 4 cst | |
| Acrylic group | KBM 5103 | 3-trimethoxysilyl- | Shin Etsu |
| containing | | propylacrylate | (China) |
| Tackifier | | | |
| Acrylic group | KBM 503 | 3-trimethoxysilyl- | Shin Etsu |
| containing | | propylmethacrylate | (China) |
| Tackifier | | | |

* All raw materials are directly used without any special treatment.

### Example 1

### <Preparation of Component A>

### Component a was Prepared by Steps of:

a) 99.94 grams of Andisil VQM 60 was weighted in speedmixer cup.
b) Then 0.06 grams of Karstedt PT1003 was added into same speedmixer cup.
c) Mixed the mixture 30 seconds at 800 rpm and 2 minutes at 2000 rpm under vacuum with FlackTek Speedmixer DAC 600.

### <Preparation of Component B>

a) 84.17 grams of Andisil VQM 60 was weighted in speedmixer cup.
b) 15.14 grams of Andisil XL 1340 was added into same speedmixer cup.
c) Mixed the mixture 30 seconds at 800 rpm and 2 minutes at 2000 rpm under vacuum with FlackTek Speedmixer DAC 600.
d) 0.69 grams of KBM 5103 was added into the cup.
e) Mixed the mixture 30 seconds at 800 rpm and 2 minutes at 2000 rpm under vacuum with FlackTek Speedmixer DAC 600.

### <Mixing Component A and Component B>

a) 50 grams of component A prepared in step 1 was weighted in speedmixer cup.
b) 50 grams of component B prepared in step 2 was added into same speedmixer cup.
c) Mixed the mixture 30 seconds at 800 rpm and 2 minutes at 2000 rpm under vacuum with FlackTek Speedmixer DAC 600.

### <Coating & Curing>

The glass bulb was coated by steps of:
a) Blew off the dust on the glass bulb
b) Dipped the glass bulb into the homogenous mixture mixed in previous step for 2-3 seconds
c) Took out the glass bulb and kept still for 3-5 seconds
d) Upturned the glass bulb and put it into 80 degree C. oven cured for 30 mins.

The coated bulb sample was subjected to various of tests.

### Example 2-3, and CE1-CE9

The coating composition of E2 to E3 and CE1 to CE9 were prepared in reference to Example 1.

The coated glass bulb of E2 to E3 and CE1 to CE9 were coated and cured in reference to Example
1. More details are listed in below result part.

### Test Methods

### <Impact Test>

Detailed impact test method refers to Underwriters Laboratories (UL) Standard for Polymeric Materials—Use in Electrical Equipment Evaluations (UL 746C, 2004), which contains specifications in section 56, resistance to impact test, to test the impact strength of samples.

Each of three samples is to be dropped through 0.91 m (3 ft) to strike a hardwood surface in the position most likely to produce adverse results. The hardwood surface is to consist of a layer of nominal 25 mm (1 inch) tongue-and-groove oak flooring (actual size 18 by 57 mm or ¾ by 2¼ inch mounted on two layers of nominal 19 mm (¾ inch) plywood. The assembly is to rest on a concrete floor or an equivalent nonresilient floor during the test.

Each sample is to be dropped three times so that, in each drop, the sample strikes the surface in a position different from those in the other two drops. Three samples shall be employed for the test; however, if the manufacturer so elects, fewer samples may be used in accordance with FIG. 1. The overall performance is acceptable upon completion of any one of the procedures represented in that figures. If any sample does not comply on its first series of three drops, the results of the test are unacceptable.

FIG. 1 Procedures for impact tests. Each series consists
of three drops as applicable

| Series | | | | | | | | | | | | |
|---|---|---|---|---|---|---|---|---|---|---|---|---|
| Num = | Sample Number | | | | | | | | | | | |
| ber | 1 | 2 | 3 | 1 | 2 | 3 | 1 | 2 | 3 | 1 | 2 | 3 |
| | [symbol] | | | [symbol] | | | [symbol] | | | [symbol] | | |
| 1 | A | N | N | A | N | N | A | N | N | A | N | N |
| | [symbol] | | | [symbol] | | | [symbol] | | | [symbol] | | |
| 2 | A | N | N | A | N | N | U | A | N | U | A | N |
| | [symbol] | | | [symbol] | | | | [symbol] | | | [symbol] | |
| 3 | A | N | N | U | A | N | | A | N | | U | A |

Arrows indicate sequence of test procedure

A—Acceptable results from drop
U—Unacceptable results from drop
N—No test necessary

Evaluation: If the coated bulb keeps as a whole, no crack, and the coating sticks on the bulb, mark it as PASS.

### <Transparency Test>

The transparency of cured coating composition was tested by Carry-300 according to ASTM D1003 with 2 mm thickness. Transmittance of greater than 90% is acceptable. Transmittance of greater than 95% is preferred.

### Results

Table 1 shows testing results of the glass bulb Examples 1 to 3 (E1-E3) and Comparative Examples 1-9 (CE1-CE9) coated by the coating composition with different formulations. The transparency test result, curing result and impact test result are given below in table 2.

TABLE 1

| | A Component | | | | | | | |
|---|---|---|---|---|---|---|---|---|
| | (weight percentage based on the total | | B Component | | | | | |
| | amount of A) | | (weight percentage based on the total amount of B) | | | Kinematic | | Mole ratio |
| | | Vinyl functional | Vinyl functional | | | viscosity of | | of —SiH |
| | Catalyst | silicon resin | silicon resin | crosslinker | Tackifier | Crosslinker | | to Vinyl |
| E1 | Karstedt Catalyst | Andisil VQM 60 | Andisil VQM 60 | Andisil X 1340 | KBM5103 | 50 | cst | 1.2335 |
| | 0.06% | 99.94% | 84.17% | 15.14% | 0.69% | | | |
| CE1 | Karstedt Catalyst | Andisil VQM 60 | Andisil VQM 60 | Andisil X 1340 | KBM5103 | 50 | cst | 0.9997 |
| | 0.06% | 99.94% | 86.86% | 12.45% | 0.69% | | | |
| CE2 | Karstedt Catalyst | Andisil VQM 60 | Andisil VQM 60 | Andisil XL 10 | KBM5103 | 45 | cst | 2.5160 |
| | 0.06% | 99.94% | 86.86% | 12.45% | 0.69% | | | |
| CE3 | Karstedt Catalyst | Andisil VQM 6 | Andisil VQM 6 | Andisil XL 10 | KBM 503 | 45 | cst | 3.0250 |
| | 0.06% | 99.94% | 83.17% | 16.14% | 0.69% | | | |
| E2 | Karstedt Catalyst | Andisil VQM 6 | Andisil VQM 6 | Andisil X 1340 | KBM5103 | 50 | cst | 1.2020 |
| | 0.06% | 99.94% | 83.17% | 16.14% | 0.69% | | | |
| E3 | Karstedt Catalyst | Andisil VQM 6 | Andisil VQM 6 | Andisil X 1340 | KBM 503 | 50 | cst | 1.2020 |
| | 0.06% | 99.94% | 83.17% | 16.14% | 0.69% | | | |
| CE4 | Karstedt Catalyst | Andisil VS 5000 | Andisil VS 5000 | Andisil X 1340 | KBM 503 | 50 | cst | 1.0610 |
| | 0.06% | 99.94% | 95.17% | 4.14% | 0.69% | | | |
| CE5 | Karstedt Catalyst | Andisil VQM 6 | Andisil VQM 6 | Andisil X 1340 | No tackifier | 50 | cst | 1.1975 |
| | 0.06% | 99.94% | 83.86% | 16.14% | | | | |
| CE6 | Karstedt Catalyst | Andisil VQM 6 | Andisil VQM 6 | Andisil X 1340 | Dynasylan | 50 | cst | 1.2020 |
| | 0.06% | 99.94% | 83.17% | 16.14% | GLYMO | | | |
| | | | | | 0.69% | | | |
| CE7 | Karstedt Catalyst | Andisil VQM 6 | Andisil VQM 6 | Andisil CE-4 | KBM 503 | 4 | cst | 1.1619 |
| | 0.06% | 99.94% | 83.17% | 16.14% | 0.69% | | | |
| CE8 | Karstedt Catalyst | Andisil VQM 6 | Andisil VQM 6 | Andisil X 1341 | KBM 503 | 40 | cst | 1.2235 |
| | 0.06% | 99.94% | 87.31% | 12% | 0.69% | | | |
| CE9 | Karstedt Catalyst | Andisil VQM 0.6 | Andisil VQM 0.6 | Andisil X 1340 | KBM5103 | 45 | cst | 1.0016 |
| | 0.06% | 99.94% | 81.17% | 18.14% | 0.69% | | | |

TABLE 2

| Exam- | Trans- | | |
|---|---|---|---|
| ple | parency | Curing result | Impact test |
| E1 | 99.2% | Coating is uniform, | Pass. Coated bulb keeps as a |
| | | no tacky area. | whole, no crack on the |
| | | | coating or bulb, coating |
| | | | integrally sticks on the bulb. |
| CE1 | 99.0% | The top of the | — |
| | | bulb is still tacky | |
| | | after curing. | |
| CE2 | 98.0% | Coating is uniform, | Fail. Coated bulb breaks |
| | | no tacky area. | into pieces, has contact |
| | | | risk of LED chips |
| CE3 | 98.5% | Coating is uniform, | Fail. Coated bulb breaks into |
| | | no tacky area. | pieces after impact test. |
| E2 | 99.1% | Coating is uniform, | Pass. Coated bulb keeps as a |
| | | no tacky area. | whole, no crack on the |
| | | | coating or bulb, coating |
| | | | integrally sticks on the bulb. |
| E3 | 99.5% | Coating is uniform, | Pass. Coated bulb keeps |
| | | no tacky area. | as a whole, no crack on the |
| | | | coating or bulb, coating |
| | | | integrally sticks on the bulb. |
| CE4 | 99.3% | Coating is uniform, | Fail. Coated bulb breaks into |
| | | no tacky area. | pieces, has contact risk of |
| | | | LED chips |
| CE5 | 98.9% | Coating is uniform, | Fail. Coating keeps as |
| | | no tacky area. | whole part, but glass bulb |
| | | | breaks into pieces. More |
| | | | than 70% area of glass |
| | | | pieces don't stick to |
| | | | the coating. |
| CE6 | 99.2% | Coating is uniform, | Fail. Coating keeps as |
| | | no tacky area. | whole part, but glass bulb |
| | | | breaks into pieces. More |
| | | | than 30% area of glass |
| | | | pieces don't stick to |
| | | | the coating. |
| CE7 | 98.8% | Coating is uniform, | Fail. Coated bulb breaks |
| | | no tacky area. | into pieces, has |
| | | | contact risk of |
| | | | LED chips |
| CE8 | 98.5% | The top of the | — |
| | | bulb is still tacky | |
| | | after curing. | |
| CE9 | 98.7% | Coating is uniform, | Fail. Coated bulb breaks |
| | | no tacky area. | into pieces, has contact |
| | | | risk of LED chips |

It was found and observed, surprisingly and unexpectedly, in Examples 1, 2 and 3 that the coating compositions cured uniformly on the glass bulb, and coated glass bulb pass the impact test perfectly. A coating composition of present invention is required to achieve these desire performances, as seen in these three examples.

Although this invention has been shown and described with respect to detailed embodiments thereof, it will be understood by those skilled in the art that various changes in form and detail thereof may be made without departing from the spirit and scope of the claimed invention.

1. A two-component silicone-based coating composition comprising:
a component (A) comprising: an effective amount of catalyst, and
a component (B) comprising: an acrylic group containing tackifier, a crosslinker comprising a pendant hydrosilyl group and an optional terminal hydrosilyl group,
wherein the component (A) and/or the component (B) comprise a vinyl functional polysiloxane polymer having a vinyl functionality of greater than 2, and a vinyl content of less than 0.27 mmol/g,
wherein the hydrosilyl group of the crosslinker is used in molar excess relative to the vinyl group of the vinyl functional polysiloxane polymer, and the mole ratio of hydrosilyl group of the crosslinker to vinyl group of the vinyl functional polysiloxane polymer being less than 1.3.

2. The composition according to claim 1, wherein the crosslinker has a kinematic viscosity of equal to or greater than 45 cst at 25° C.

3. The composition according to claim 1, wherein vinyl functional polysiloxane polymer is selected from the group consisting of vinyl terminated: polydialkylsiloxane, polydimethylsiloxane, polydiphenylsilane-dimethylsiloxane copolymer, polyphenylmethylsiloxane, polyfluoropropylmethyl-dimethylsiloxane copolymer and polydiethylsiloxane.

4. The composition according to claim 1, wherein vinyl functional polysiloxane polymer has a vinyl content of less than 0.21 mmol/g.

5. The composition according to claim 1, wherein the crosslinker is selected from the group consisting of polymethylhydrogensiloxane, polymethylhydrogen-polydimethylsiloxane copolymer, polyethylhydrogensiloxane, methyl Hydrogensiloxane-octylmethylsiloxane copolymer and methylhydrogensiloxane-methylphenylsiloxane copolymer.

6. The composition according to claim 1, wherein the acrylic group containing tackifier comprises (meth)acrylic group containing resin and/or (meth)acrylic group containing silane.

7. The composition according to claim 1, wherein the content of the acrylic group containing tackifier is 0.2 wt. % to 5 wt. % based on the total weight of the composition.

8. The composition according to claim 1, wherein the catalyst is selected from a group consisting of platinum, palladium, rhodium, nickel, iridium, ruthenium, cobalt, ferrum, cuprum catalyst, and mixtures thereof.

9. The composition according to claim 1, wherein the composition further comprises 5 wt. % to 90 wt. % of organic solvent based on the total weight of the composition.

10. An addition-crosslinked reaction product of the two-component silicone-based coating composition of claim 1.

11. The reaction product of claim 10, wherein the reaction product has a transmittance of greater than or equal to 95%.

12. An article includes a coating of the reaction product of claim 10 on a glass surface.

13. The article of claim 12, wherein the article has an anti-impact property characterized by the article keeping as a whole with no crack when subjected to UL-746C impact test.

14. (canceled)

15. A method for coating an article with a glass surface using the composition according to claim 1, comprising steps of:
a) mixing component (A) and component (B),
b) dip-coating an article with glass surface in the mixture formed in step (a), or diluting the mixture formed in step (a) and then spraying the diluted mixture to an article with glass surface to form a coating on the glass surface,
c) curing the coating on the glass surface.
